(19) United States
(12) Patent Application Publication
(10) Pub. No.: US 2008/0299924 A1
(43) Pub. Date: Dec. 4, 2008

(54) INFORMATION PROCESSOR AND CONTROL METHOD THEREOF

(75) Inventor: Anwar Sathath, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/130,921

(22) Filed: May 30, 2008

(30) Foreign Application Priority Data
May 31, 2007 (JP) 2007-145910

(51) Int. Cl. H04B 1/034

(52) U.S. Cl. 455/128; 455/129

(57) ABSTRACT

According to one embodiment, An information processor includes a main unit, a display unit configured to be connected to the main unit so as to be rotated, an antenna configured to be built into the display unit, a detection unit configured to detect a state of the display unit, a storage unit configured to store a gain value of the antenna corresponding to the state of the display unit, and a setting unit configured to read to set the gain value of the antenna from the storage unit in response to the state of the display unit detected by the detection unit.

### CROSS-REFERENCE TO RELATED APPLICATIONS

This application is based upon and claims the benefit of priority from Japanese Patent Application No. 2007-145910, filed May 31, 2007, the entire contents of which are incorporated herein by reference.

### BACKGROUND

1. Field

One embodiment of the present invention relates to an information processor such as a personal computer. More specifically, the present invention relates to an information processor which has a radio antenna unit built-in and a control method for use in the information processor.

2. Description of the Related Art

In general, an antenna to be used for a radio communication apparatus or the like generates a power loss caused by the reception state of an electric wave. Jpn. Pat. Appln. KOKAI Publication No. 2002-290262 has disclosed a radio communication apparatus which changes the gain limit values into different values corresponding to the power losses of the respective antennas in the use of a first antenna and a second antenna, respectively.

However, since the technique which has been described in Jpn. Pat. Appln. KOKAI Publication No. 2002-290262 decides transmission power corresponding to the power loss; the technique produces the problem of not being able to always make the transmission power maximum.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view depicting overview of a computer regarding an embodiment of the invention;

FIG. 2 is an exemplary block diagram depicting example of a system configuration of the computer regarding the embodiment of the invention;

FIG. 3 is an exemplary block diagram depicting configuration of a function regarding the embodiment of the invention;

FIG. 4 is an exemplary flowchart depicting a control method with the computer regarding the embodiment of the invention adapted thereto;

FIG. 5 is an exemplary schematic view depicting setting table for each state of a display unit 12; and

FIG. 6 is an exemplary schematic view depicting example of the setting table.

### DETAILED DESCRIPTION

Various embodiments according to the invention will be described hereinafter with reference to the accompanying drawings. In general, according to one embodiment of the invention, an information processor comprising: an information processor includes: a main unit; a display unit configured to be connected to the main unit so as to be rotated; an antenna configured to be built into the display unit; a detection unit configured to detect a state of the display unit; a storage unit configured to store a gain value of the antenna corresponding to the state of the display unit; and a setting unit configured to read to set the gain value of the antenna from the storage unit in response to the state of the display unit detected by the detection unit.

Further, there is provided a control method for use in an information processor equipped with a main unit, a display unit configured to be connected to the main unit so as to be rotated, an antenna configured to be built into the display unit, a detection unit configured to detect a state of the display unit, and a storage unit configured to store a gain value of the antenna corresponding to the display unit, comprising: reading the gain value of the antenna from the storage unit in response to the state of the display unit detected by the detection unit; and setting maximum transmission power of the antenna on the basis of the read gain value of the antenna.

According to the invention, it becomes able to optimally control the transmission power in response to the use state of the antenna.

Hereinafter, embodiments of the invention will be described with reference to the drawings.

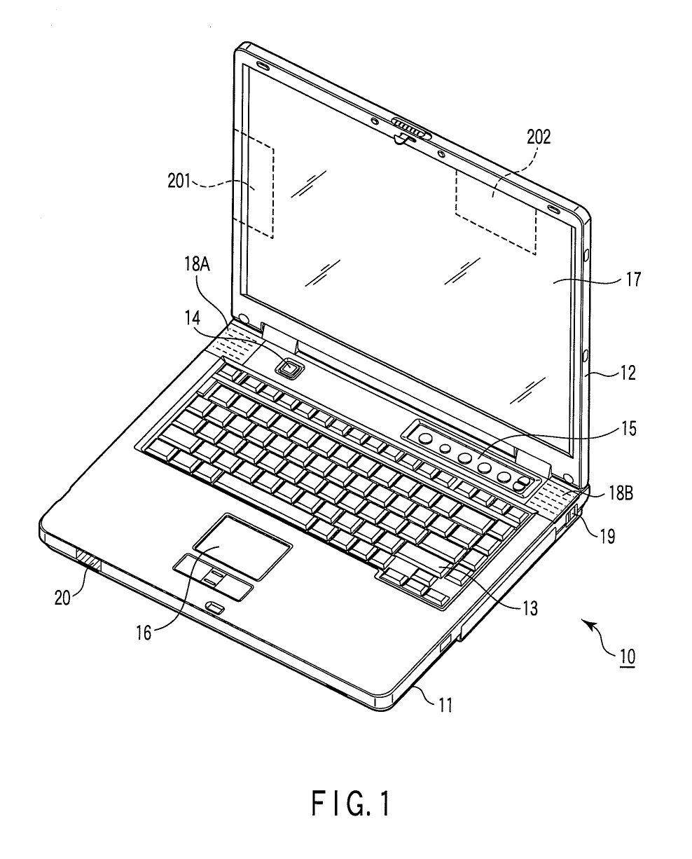

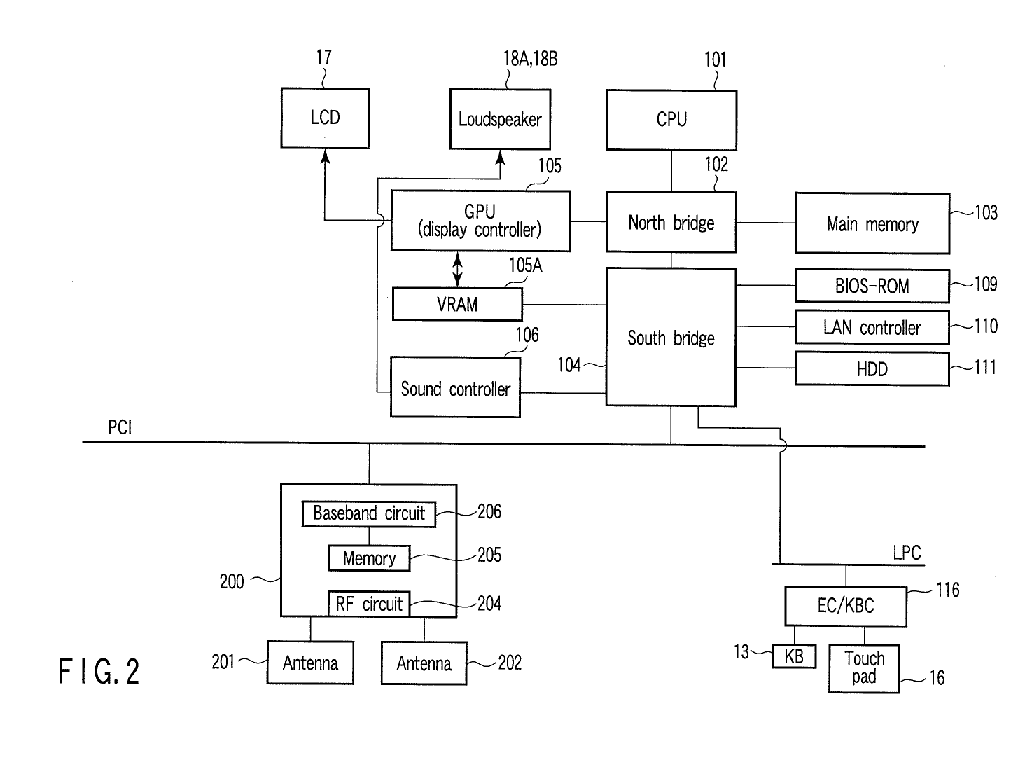

Referring now to FIGS. 1 and 2, the configuration of an information processor regarding an embodiment of the invention will be described. The information processor is actualized, for example, as a notebook-type personal computer 10.

FIG. 1 shows a perspective view in a state in which a display unit of the personal computer 10 is open. The computer 10 is composed of a computer main unit 11, and a display unit 12. The display unit 12 has a display device. The display unit 12 has a thin-film transistor liquid crystal display (TFT-LCD) 17 built-in, and the display screen of the LCD 17 is positioned at the almost center of the display unit 12. The display unit 12 has antennas 201, 202 for performing radio communication built-in.

The display unit 12 is attached to the computer main unit 11 so as to freely rotate between an open position and a close position of the display unit 12. The computer main unit 11 has a thin box-type housing, a keyboard 13, a power button 14 for powering on/powering off the computer 10, an input operation panel 15, a touch pad 16, loudspeakers 18A, 18B, a infra-red ray reception unit 20 or the like are arranged on the upper surface of the housing.

The input operation panel 15 is an input device to input an event corresponding to the depressed button, and includes a plurality of buttons for starting a plurality of functions, respectively.

Next, the system configuration of the computer 10 will be described by referring to FIG. 2.

The computer 10 includes, as shown in FIG. 2, a CPU 101, a north bridge 102, a main memory 103, a south bridge 104, a GPU 105, a BIOS-ROM 109, a LAN controller 110, A hard disk drive (HDD) 111, an embedded controller/keyboard controller IC(EC/KBC) 116, a radio communication module 200, antennas 201, 202. The radio communication module 200 has a baseband circuit 206, a memory 205 with a table showing antenna gain values, etc., stored thereon, and a radio-frequency (RF) circuit 204.

The CPU 101 is a processor for controlling operations of the computer 10, and executes an operating system and various applications to be loaded on the main memory 103 from the HDD 111. The CPU 101 also executes a basic input output system (BIOS) stored on the BIOS-ROM 109. The BIOS is a program for controlling hardware.

The north bridge 102 is a bridge device connecting between a local bus of the CPU 101 and the south bridge 104. The north bridge also has a memory controller to perform access control of the main memory 103 built-in. The north bridge 102 also has a function of making communication with the GPU 105 via a serial bus, etc., conforming to PCI Express standards.

The GPU 105 is a display controller controlling the LCD 17 to be used as a display monitor of the computer 10. A display signal to be generated by the GPU 105 is sent to the LCD 17.

The south bridge 104 controls each device on a low pin count (LPC) bus and each device on a peripheral component interconnect (PCI) bus. The south bridge 104 has an integrated drive electronics (IDE) controller to control the HDD 111.

The IC (EC/KBC) 116 is a one chip microcomputer with an embedded controller for power management and a keyboard controller for controlling the keyboard (KB) 13 and the touch pad 16 integrated thereon. The IC (EC/KBC) 116 has a function of powering on/powering off the computer 10 in response to the operations of the power buttons by a user.

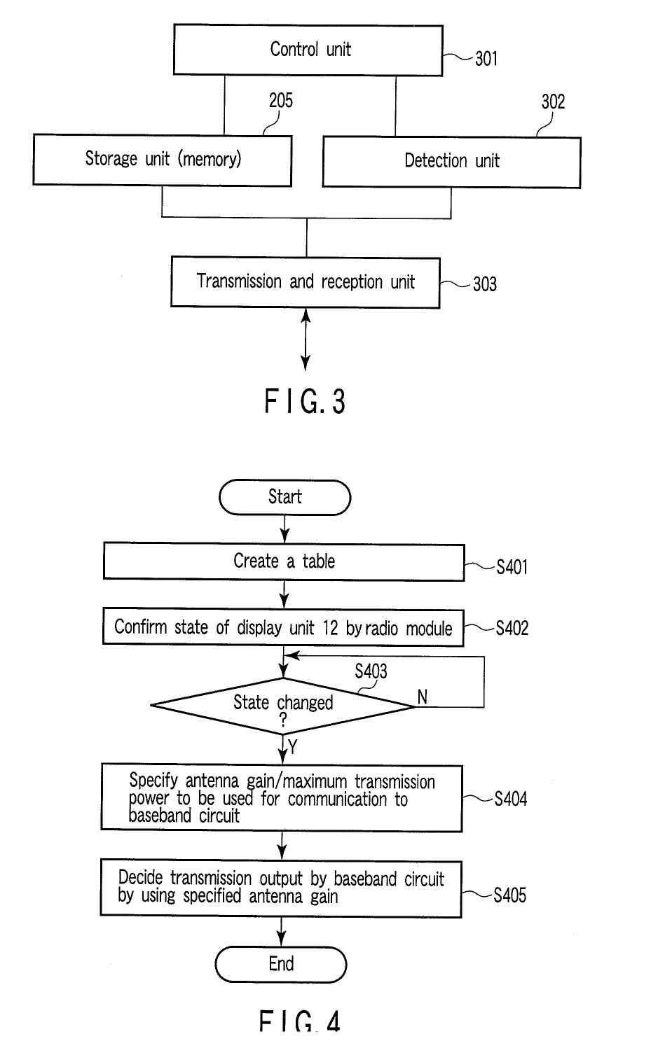

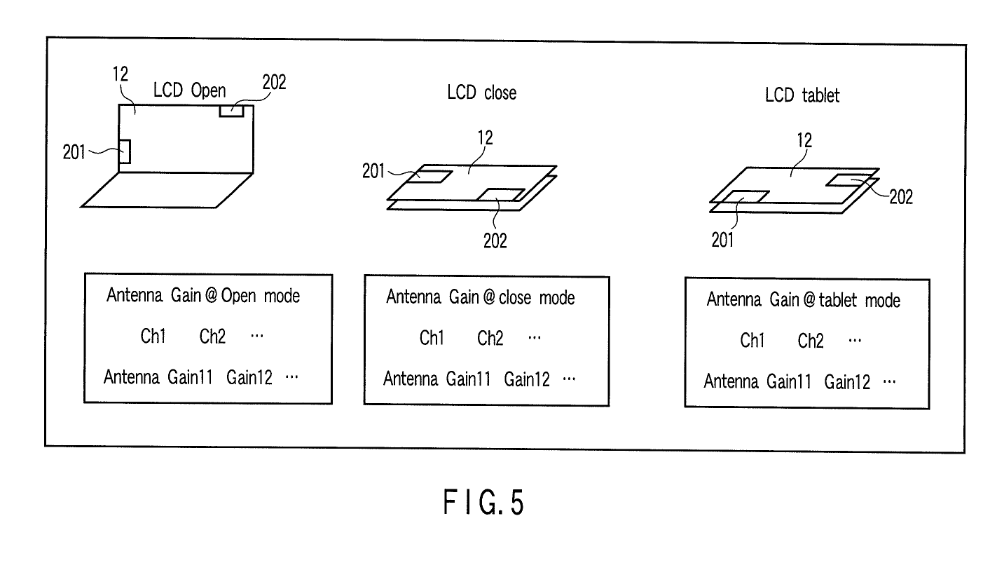

FIG. 3 shows a block diagram illustrating the functional configuration regarding the embodiment of the information processor of the invention.

The personal computer 10 includes a control unit 301, a storage unit 205, a detection unit 302, and a transmission and reception unit 303, and the functions which have owned by these units are realized in cooperation with a variety of items of hardware and software.

The control unit 301 sets antenna gain values for the antennas 201, 202 and controls output power therefrom. The table showing the antenna gain values, etc., is stored in the storage unit 205 as given below. The detection unit 302 including the BIOS-RON 109 detects the open/close state of the display unit 12. If the personal computer (PC) is a tablet PC, the detection unit 302 detects a tablet state (a state in which the tablet PC is closed so that the LCD 17 of the display unit 12 is closed) or the like in addition to the state of the closed state or opened state of the display unit 12. The transmission and reception unit 303 is composed of the radio communication module 200, the antennas 201, 202, etc.

A control method which adapts to the information processor regarding the invention will be described by referring to the flowchart of FIG. 4.

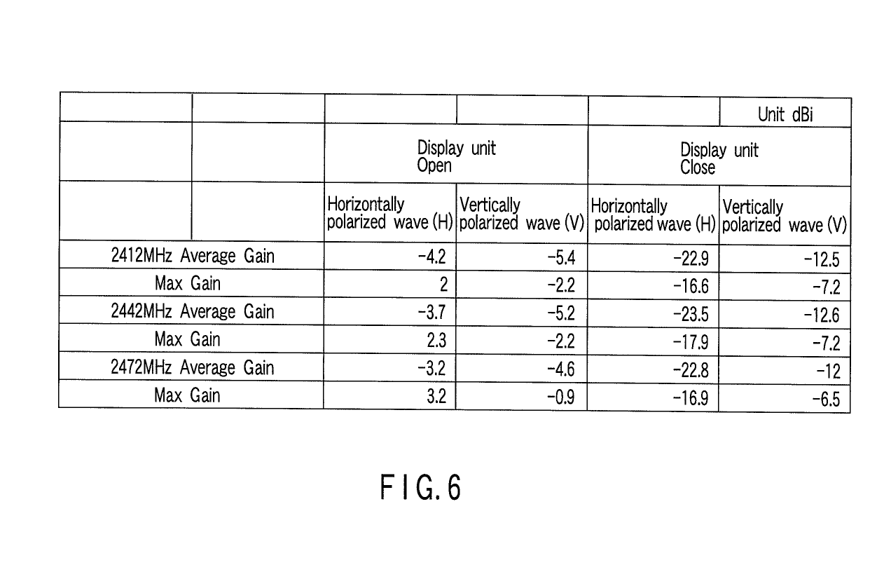

Firstly, the control method creates the table showing the gain values of the states of the respective antennas and stores the values in the memory 205 (Block S401). The table shows the antenna gain values of a horizontally polarized wave and a vertically polarized wave corresponding to the open/close state of the display unit 12 and the frequency band to be used for the communication. For instance, in the case in which the display unit 12 is an open state as shown in FIG. 6, for example, at 2412 MHz, an average gain and a maximum gain of the horizontally polarized waves (H) become −5.4, and 2, respectively, and an average gain and a maximum gain of the vertically polarized waves (V) become −5.4, and −2.2, respectively. In the case in which the display unit 12 is a close state, for example, at 2412 MHz, an average gain and a maximum gain of the horizontally polarized waves (H) become −22.9, and −16.6, respectively, and an average gain and a maximum gain of the vertically polarized waves (V) become −12.5, and −7.2, respectively.

The detection unit 302 confirms the state of the display unit 12 (Block S402). The PC 10 grasps the state of the display unit 12 from the BIOS-ROM 109, and reports the state to a device driver of the radio communication module 200. It is also acceptable to access the BIOS-ROM 109 from the device driver.

For instance, if the display unit 12 changes its state from the open state to the close state (YES in Block S403), the control unit 301 reads the antenna gain values corresponding to the state of the display unit 12 from the memory 205. The control unit 301 specifies the read antenna gain values and a maximum transmission power value corresponding to a communication system to the baseband circuit 206 (Block S404). The defined values of the maximum power value in response to the state of the display unit 12 and to frequency bands to be used in the communication are stored in the table, as shown in FIG. 6. The baseband circuit 206 decides the transmission output on the basis of the specified antenna gain values (Block S405). Like this, by controlling the transmission output in accordance with the open/close state of the display unit 12, the control method may prevent the deterioration of the antenna gains, the transmission output, and the radio communication performance in the close state (close/tablet mode, etc.) of the display unit 12 in comparison with the case in which where the transmission output is uniquely decided on the basis of the antenna gain value in the open state of the display unit 12. In other words, since the method may set the transmission outputs and the antenna gain values corresponding to each state of the display unit 12 equipped with the antennas 201, 202, the method may make radio communication in a state in which the radio communication performance (radio arrival distance) is improved as much as possible.

It is our intention that the invention not be limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from the whole of the constituent elements shown in the embodiments mentioned above. Further, the constituent elements over different embodiments may be appropriately combined.

The present invention has been achieved in consideration of the aforementioned circumstances; an object of the invention is to provide an information processor configured to optimally control transmission power corresponding to the use state of antennas and a control method of the information processor.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a main unit;
a display unit configured to be connected to the main unit so as to be rotatable between a plurality of states;
an antenna built into the display unit;
a detection unit configured to detect the rotational state of the display unit;
a storage unit configured to store a gain value of the antenna corresponding to the rotational state of the display unit; and
a setting unit configured to set the gain value of the antenna to the corresponding gain value stored in the storage unit in response to the rotational state of the display unit detected by the detection unit.

2. The processor of claim 1, wherein
the setting unit is configured to set maximum transmission power of the antenna in response to the rotational state of the display unit.

3. The processor of claim 1, wherein
the gain value is stored in the storage unit for each channel of frequencies.

4. The processor of claim 1, wherein
the detection unit is configured to detect whether the display unit is in an open rotational state or a tablet mode rotational state.

5. A control method for use in an information processor equipped with a main unit, a display unit configured to be connected to the main unit so as to be rotatable between a plurality of rotational states, an antenna built into the display unit, a detection unit configured to detect the rotational state of the display unit, and a storage unit configured to store a gain value of the antenna corresponding to the rotational state of the display unit, comprising:
detecting the rotational state of the display unit;
reading the gain value of the antenna from the storage unit corresponding to the rotational state of the display unit detected by the detection unit; and
setting maximum transmission power of the antenna on the basis of the read gain value of the antenna.
